(19) United States
(12) Patent Application Publication
(10) Pub. No.: US 2012/0002884 A1
(43) Pub. Date: Jan. 5, 2012

(54) METHOD AND APPARATUS FOR MANAGING VIDEO CONTENT

(75) Inventors: Yansong Ren, Plano, TX (US); Fangzhe Chang, Edison, NJ (US); Thomas L. Wood, Colts Neck, NJ (US); James Robert Ensor, Red Bank, NJ (US)

(73) Assignee: Alcatel-Lucent USA Inc.

(21) Appl. No.: 12/827,714

(22) Filed: Jun. 30, 2010

(51) Int. Cl. G06K 9/68; G06F 17/30

(52) U.S. Cl. 382/218; 707/769; 707/E17.014

(57) ABSTRACT

Video files stored in a data store are managed by analyzing the semantic relationship of at least one associated descriptive tag of a given video file to tags associated with video files in the data store. The results of the analysis are used to select a set of video files from those stored in the data store. The content of the given video file is compared with the content of the selected set to determine the similarity of the content. The results of the determination may be used to update information concerning the similarity of video files in the data store, for example, to be used in providing results in response to a search query.

### FIELD OF THE INVENTION

The present invention relates to a method and apparatus for managing video content and more particularly, but not exclusively, to circumstances in which a user uploads video content to a video hosting site for access by others.

### BACKGROUND

In a video hosting website, such as, for example, YouTube, Google Video and Yahoo! Video, video content may be uploaded by users to the site and made available to others via search engines. It is believed that current web video search engines provide a list of search results ranked according to their relevance scores based on a particular a text query entered by a user. The user must then consider the results to find the video or videos of interest.

Since it is easy for users to upload videos to a host, obtain videos and distribute them again with some modifications, there are potentially numerous duplicate, or near duplicate, contents in the video searching results. For example, the duplicate video content may include videos with different formats, encoding parameters, photometric variations, such as color and lighting, user editing and content modification, and the like. This can make it difficult or inconvenient to find the content actually desired by the user. For instance, based on samples of queries from YouTube, Google Video and Yahoo! Video, on average it was found that there are more than 27% near-duplicate videos listed in search results, with popular videos being the most duplicated in the results. Given a high percentage of duplicate videos in search results, users must spend significant time to sift through them to find the videos they need and must repeatedly watch similar copies of videos which have already been viewed.

When users search videos from websites, they are typically interested in results shown on the first screen. The duplicate results depreciate users' experience of video search, retrieval and browsing. In addition, such duplicated video content increases network overhead by storing and transferring duplicated video data across network.

### BRIEF SUMMARY

According to a first aspect of the invention, a method of managing video content includes taking a given video file having at least one associated tag descriptive of the content of the given video file. The semantic relationship of the at least one associated tag to tags associated with a plurality of video files in a data store is analyzed. The results of the analysis are used to select a set of video files from the plurality. The content of the given video file is compared with the content of the selected set to determine the similarity of the content. The results of the determination are used to update information concerning the similarity of video files in the data store.

By using semantic information from tags to identify those video files likely to have similar content, it allows a set of video files to be chosen for further processing from the total number available prior to duplicate detection by comparing the given video with those included in the set. By reducing the amount of content that must be considered, it makes it more efficient and less resource intensive to apply video duplication detection techniques.

It is particularly useful to hold information concerning similarity of video files in the data store for improving video search results, but it may also be advantageous for other purposes, for example, for organizing archived content. Video duplicate and similarity detection is useful for its potential in searching, topic tracking and copyright protection.

The tags may be user generated. For example, when a user uploads a video file to a hosting website, they may be invited to add keywords or other descriptors. There is an incentive to users to use accurate and informative tags in order for the content to be readily found by others who might wish to view it. The user who adds the tag or tags need not be the person who added the video file to the data store however. For example, a person may be tasked with indexing already archived content. In one method, some degree of automation may be involved in providing tags instead of them being allocated by users, but this may tend to provide less valuable semantic information.

The method may be applied when the given video file is to be added to the data store. However, it may be used to manage video content that has previously been added to the data store, so as to, for example, refine information regarding similarity of video content held by the data store.

In one embodiment, any one of the video files included in the data store may be taken as the given video file and act as a query to find similar video files in the data store.

According to another aspect of the invention, a device is programmed or configured to perform a method in accordance with the first aspect.

### BRIEF DESCRIPTION OF THE DRAWINGS

Some embodiments of the present invention will now be described by of example only, and with reference to the accompanying drawings, in which:

FIG. 1 schematically illustrates an implementation in accordance with the invention; and

FIG. 2 schematically illustrates part of a video duplication detection step of the implementation of FIG. 1.

### DETAILED DESCRIPTION

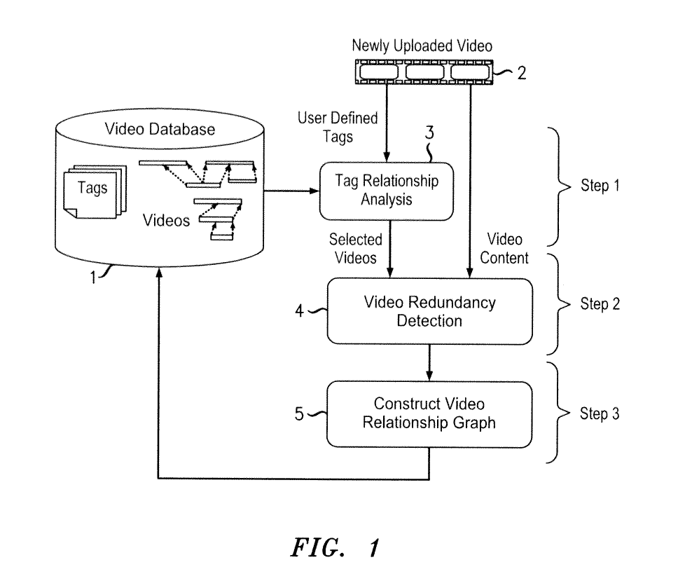

With reference to FIG. 1, a video hosting website includes a video database 1, which holds video content, tags associated with the video content and information concerning the relationship of content. When a user uploads a new video 2, they also assign tags to the video content. A tag is a keyword or term that is in some way descriptive of the content of the video file. A tag provides a personal view of the video content and thus provides part of the video semantic information.

The first step is to use the tags to select videos already included in the video database 1 that could be semantically correlated with the newly uploaded video 1. This is carried out by a tag relationship processor 3 which accepts tags associated with the new video 2 and those associated with previously uploaded videos from the database 1.

Since users normally assign more than one tag to a video content, there is a need to determine the relationships among tags. Generally, there are two types of relationships: AND or OR. Applying different relationships to tags gives different results.

Applying only an AND relationship among tags causes those videos to be selected that are associated with each one of the tags. This may result in some videos being excluded that are actually semantically correlated to the newly uploaded video. For example, if a newly uploaded video is tagged as “Susan Boyle” and “from Scotland” and an AND relationship is applied, the selected videos must have both “Susan Boyle” and “from Scotland” as associated tags. Since the frequency for the tags “from Scotland” and “Susan Boyle” appearing together is very low, the selected video set does not include many videos that are tagged only with “Susan Boyle”. However, the latter are most likely semantically related to the newly uploaded video.

Applying only an OR relationship among tags, may result in selecting more videos than necessary. For example, if a newly uploaded video is tagged as “apple” and “ipod” the selected set may include both videos about “iphone” and videos about “apple-fruit”, but the latter are unlikely to be semantically related to the newly uploaded video.

In the tag relationship analysis at 3, semantic information is used to provide useful selection of a set of video files for further processing to detect duplicates or near duplicates. To derive the proper relationships among multiple tags, tag co-occurrence information is measured, based on collective knowledge from a large amount of tags associated with existing video files previously added to the database 1. Tag co-occurrence contains useful information to capture tags' similarity in the semantic domain. When the probability of tags appearing together is high, above a given value say, an AND relation is used to select videos retrieved by multiple tags. When the probability of tags co-occurrence is low, below the given value, videos associated with those tags are selected based on several criteria, such as the frequency of tag appearing, the popularity of the tags, or other suitable parameters. This selection helps reduce the total number of video files to be considered.

Thus, for a particular newly uploaded video, if there is more than one tag assigned by user, the relationships among the tags is derived by processor 3. Since there is a large quantity of videos being tagged in video hosting website, the tags from existing videos provide collective knowledge base for determining tag relationships.

Tag co-occurrence frequency is calculated as a measurement of tag relationships. There are several methods for calculating tag co-occurrence. For example, using the equation:

$$P ( {tag}_{j} \vert {tag}_{i} ) = \frac{\vert {tag}_{i} ⋂ {tag}_{j} \vert}{\vert {tag}_{i} \vert}$$

This indicates the frequency that tagᵢ appeared together with tagⱼ and is normalized by the total frequency of tagᵢ. Similarly, given tagⱼ, the frequency of tagᵢ and tagⱼ co-occurrence can be calculated. This above equation provides asymmetric relevance measurement among tagᵢ and tagⱼ.

Symmetric relevance among tags can also be measured using the Jaccard coefficient, as shown below:

$$P ( {tag}_{i} , {tag}_{j} ) = \frac{\vert {tag}_{i} ⋂ {tag}_{j} \vert}{\vert {tag}_{i} ⋃ {tag}_{j} \vert}$$

The coefficient takes the number of intersections between the two tags, divided by the union of the two tags.

The video database 1 is queried based on the tag relationships. For instance, if a newly uploaded video is tagged as “apple” and “ipod”, the high frequency of tag “apple” and tag “ipod” occurring together suggests that the new video could be semantically related to “phone” instead of “fruit”. In another example, a newly uploaded video is tagged as “Susan Boyle” and “from Scotland”. Since the probability of both tags co-occurrence is quite low, while the frequency of tag “Susan Boyle” occurring is much higher than the frequency of tag “from Scotland”, the first tag is considered as being more important than the second one and the first tag is used to retrieve videos from database. Thus the tag relationship analysis can reduce the search space by selecting videos that semantically related with the new video.

The next step is to compare the newly uploaded video 2 against the set of selected videos to detect duplication at a video redundancy detection processor 4.

In the video duplication detection procedure for this implementation, the process includes 1) partitioning a video into a set of shots; 2) extracting a representative keyframe for each shot; and 3) comparing color, texture and shape features among keyframes between videos.

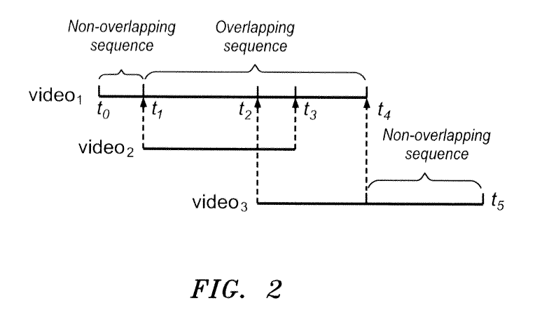

Before carrying out the duplicate detection, a video relationship graph is constructed at 5 to represent the relationship among the videos included in the set selected at 3. When two videos contain near-duplicate sequences, the graph indicates both the overlapping sequences, as well as the non-overlapping sequences, as illustrated in FIG. 2. There are three videos in the example. Video1 overlaps video2 completely, and part of video3 overlaps with both video1 and video2. To avoid comparing the newly uploaded video with the same overlapping video sequences multiple times, a list of non-overlapping video sequences is selected from the three videos in the graph shown in FIG. 2. In this example, the selected video sequences include the whole video sequence from video1 and also the video sequences from time t₄ to t₅ in video3. This selection ensures the overlapping video sequence from time t₁ to t₂ need only be matched a single time against the newly uploaded video, instead of multiple times. This step further reduces the matching space for duplication detection.

Using the matching results, the newly uploaded video 2 is added to the video relationship graph and included in the video database. The newly updated constructed video relationship graph is then used in future duplication detection to reduce the overall matching space.

The functions of the various elements shown in FIG. 1, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of managing video content including:
taking a given video file having at least one associated tag descriptive of the content of the given video file;
analyzing the semantic relationship of the at least one associated tag to tags associated with a plurality of video files in a data store;
using the results of the analysis to select a set of video files from the plurality;
comparing the content of the given video file with the content of the selected set to determine the similarity of the content; and
using the results of the determination to update information concerning the similarity of video files in the data store.

2. The method as claimed in claim 1 and wherein the semantic relationship is derived using the probability of tag co-occurrence.

3. The method as claimed in claim 2 and, where the probability is greater than a given value, applying an AND operand to at least two tags in making the set selection; and, where the probability is less than the given value, using one or more other criteria to make the set selection.

4. The method as claimed in claim 3 and wherein the other criteria include at least one of: the frequency of a tag appearing; and the popularity of a tag.

5. The method as claimed in claim 1 and wherein the given video file is added to the data store by a user.

6. The method as claimed in claim 5 and wherein the user allocates the at least one tag for association with the given video file.

7. The method as claimed in claim 1 and including using the information concerning the similarity of video files in the data store in providing results in response to a search query.

8. The method as claimed in claim 1 and including:
arranging video files included in the selected set in a video relationship graph to indicate overlapping content of video files in the selected set; and using the video relationship graph to determine the similarity of the content of the given video file and the selected set.

9. The method as claimed in claim 8 and wherein, following arranging video files included in the selected set in a video relationship graph, the content of the given video file is compared with non-overlapping content of the selected set.

10. The method as claimed in claim 8 and including updating the video relationship graph to include information from the given video file.

11. The method as claimed in claim 2 and including calculating the probability of tag co-occurrence using the equation
$$P ( {tag}_{j} \vert {tag}_{i} ) = \frac{\vert {tag}_{i} ⋂ {tag}_{j} \vert}{\vert {tag}_{i} \vert}$$

12. The method as claimed in claim 2 and including calculating the probability of tag co-occurrence using the Jaccard coefficient
$$P ( {tag}_{i} , {tag}_{j} ) = \frac{\vert {tag}_{i} ⋂ {tag}_{j} \vert}{\vert {tag}_{i} ⋃ {tag}_{j} \vert}$$

13. A device programmed or configured to perform a method comprising the steps of:
taking a given video file having at least one associated tag descriptive of the content of the given video file;
analyzing the semantic relationship of the at least one associated tag to tags associated with a plurality of video files in a data store;
using the results of the analysis to select a set of video files from the plurality;
comparing the content of the given video file with the content of the selected set to determine the similarity of the content; and
using the results of the determination to update information concerning the similarity of video files in the data store.

14. The device as claimed in claim 13 and programmed or configured to derive the semantic relationship using the probability of tag co-occurrence.

15. The device as claimed in claim 14 and programmed or configured to, where the probability is greater than a given value, apply an AND operand to at least two tags in making the set selection; and, where the probability is less than the given value, using one or more other criteria to make the set selection.

16. The device as claimed in claim 15 and wherein the other criteria include at least one of: the frequency of a tag appearing; and the popularity of a tag.

17. The device as claimed in claim 13 and wherein the given video file is added to the data store by a user.

18. The device as claimed in claim 17 and wherein the user allocates the at least one tag for association with the given video file.

19. The device as claimed in claim 13 and programmed or configured to use the information concerning the similarity of video files in the data store in providing results in response to a search query.

20. The device as claimed in claim 13 and programmed or configured to include the steps of:
arranging video files included in the selected set in a video relationship graph to indicate overlapping content of video files in the selected set; and using the video relationship graph to determine the similarity of the content of the given video file and the selected set.

21. The device as claimed in claim 20 and programmed or configured to include the step of following arranging video files included in the selected set in a video relationship graph, comparing the content of the given video file with non-overlapping content of the selected set.

22. The device as claimed in claim 20 and programmed or configured to include the step of updating the video relationship graph to include information from the given video file.

23. The device as claimed in claim 13 and programmed or configured to calculate the probability of tag co-occurrence using the equation
$$P ( {tag}_{j} \vert {tag}_{i} ) = \frac{\vert {tag}_{i} ⋂ {tag}_{j} \vert}{\vert {tag}_{i} \vert}$$

24. The device as claimed in claim 13 and programmed or configured to calculate the probability of tag co-occurrence using the Jaccard coefficient
$$P ( {tag}_{i} , {tag}_{j} ) = \frac{\vert {tag}_{i} ⋂ {tag}_{j} \vert}{\vert {tag}_{i} ⋃ {tag}_{j} \vert}$$

25. A data storage medium storing a machine-executable program for performing a method of managing video content including the steps of:
taking a given video file having at least one associated tag descriptive of the content of the given video file;
analyzing the semantic relationship of the at least one associated tag to tags associated with a plurality of video files in a data store;
using the results of the analysis to select a set of video files from the plurality;
comparing the content of the given video file with the content of the selected set to determine the similarity of the content; and
using the results of the determination to update information concerning the similarity of video files in the data store.
